(19) United States
(12) Patent Application Publication
(10) Pub. No.: US 2009/0260285 A1
(43) Pub. Date: Oct. 22, 2009

(54) Self-orientating plant pot and tray system

(76) Inventors: Thomas J. Smith, Carleton, MI (US); Henry L. Huntington, Loudon, NH (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/148,348

(22) Filed: Apr. 18, 2008

(51) Int. Cl. A01G 9/02

(52) U.S. Cl. 47/86

(57) ABSTRACT

Disclosed herein is a self-orientating plant pot and tray system. The plant pot includes a top and/or a pot body and is provided with a first drain opening. The top has a first substantially elliptical cross-section and/or the body has a first tapering substantially elliptical cross-section. The tray defines at least one receiving area each for securingly receiving a plant pot in a desired orientation relative therewith. The receiving area includes an upper chamber and/or a body chamber, which are each respectively defined by a depression and/or a receptacle. The depression has a second substantially elliptical cross-section for mating with the top and/or the receptacle has a second tapering substantially elliptical cross-section for mating with the pot body. The receptacle can be provided with a second drain opening for fluid communication with the first drain opening.

### FIELD OF THE INVENTION

The present invention relates generally to plant pots and trays, and, more particularly, to a plant pot and tray system for positioning plant pots in a desired orientation.

### BACKGROUND OF THE INVENTION

It is common for a plant pot to be provided with a plant tag to identify the plant in the pot. The tag may be positioned in the soil in the pot or in a slot in the pot such that the plant pot, when rotated between various orientations, would provide different views of the plant tag at different angles. While having a choice of multiple views can be advantageous, it is not uncommon for a plant pot to be displayed in a desired orientation at the point-of-sale, such that the tags are facing in the same direction and easily viewed. However, the desired orientation of the plant pot is vulnerable to altercations, such as when a customer at the point-of-sale inadvertently “bumps” into the plant pot or when the pot is placed in the tray at an angle. What is needed in the art is a plant pot and tray system that overcomes these and other disadvantages and shortcomings of the prior art.

### SUMMARY OF THE INVENTION

The present invention overcomes the disadvantages and shortcomings of the prior art by providing a self-orientating plant pot and tray system in which an interference fit is provided for inhibiting rotation of a plant pot when positioned in a tray therefor.

In a first aspect, the self-orientating plant pot and tray system includes a plant pot that has a drain opening and a top with a first substantially elliptical cross-section. A tray is also provided, which has a receiving area for securingly receiving the plant pot into a desired orientation. The receiving area includes a depression having a chamber of a second substantially elliptical cross-section that corresponds to the first substantially elliptical cross-section, such that the depression is configured to mate with the top of the pot to inhibit rotation of the plant pot.

In a second aspect, the self-orientating plant pot and tray system additionally or alternatively has a first tapering substantially elliptical cross-section. A tray is provided with the receiving area, which can include a receptacle defining a chamber of a second tapering substantially elliptical cross-section that corresponds to the first tapering substantially elliptical cross-section, such that the receptacle is configured to mate with a body of the plant pot to inhibit rotation thereof.

As shown and herein discussed, however, it is contemplated that a self-orientating system can be provided with both aspects, e.g., with a mating top and depression, as well as with a mating body and receptacle. Additional features, functions and benefits of the disclosed self-orientating plant pot and tray system will be apparent from the detailed description which follows, particularly when read in conjunction with the accompanying figures.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a perspective exploded view showing a self-orientating plant pot and tray system constructed in accordance with a first embodiment of the present invention, said plant pot and tray system being shown to include a plurality of plant pots and a tray having a plurality of receiving areas for the plant pots;

FIG. 2 is a perspective assembly view of the plant pot and tray system of FIG. 1;

FIG. 3 is a top plan view of the plant pot and tray system of FIGS. 1-2;

FIG. 4 is a bottom plan view of the plant pot and tray system of FIGS. 1-3;

FIG. 5 is a front elevational view of the plant pot and tray system of FIGS. 1-4;

FIG. 6 is a left side elevational view of the plant pot and tray system of FIGS. 1-5;

FIG. 7 is a top plan view of the tray of FIGS. 1-6;

FIG. 8 is a bottom plan view of the tray of FIGS. 1-7;

FIG. 9 is a front elevational view of one of the plurality of plant pots of FIGS. 1-6, a rear elevational view being identical thereto;

FIG. 10 is a left side elevational view of the one of the plurality of plant pots of FIG. 9, a right side elevational view being identical thereto;

FIG. 11 is a top plan view of the one of the plurality of plant pots of FIGS. 1-6 and 9-10;

FIG. 12A is a cross-sectional view showing one of the plurality of receiving areas mating with one of the plurality of plant pots, the cross-section having been taken along section line 12A-12A of FIG. 3;

FIG. 12B is a cross-sectional view similar to FIG. 12A, but with the plant pot having been omitted;

FIG. 13 is a cross-sectional view showing a depression of one of the plurality of receiving areas mating with a top of one of the plurality of plant pots, the cross-section having been taken along section line 13-13 of FIG. 5;

FIG. 14 is a cross-sectional view showing a receptacle of one of the plurality of receiving areas mating with a pot body of one of the plurality of plant pots, the cross-section having been taken along section line 14-14 of FIG. 5;

FIG. 15 is another cross-sectional view showing the receptacle mating with the pot body, the cross-section having been taken along section line 15-15 of FIG. 5;

FIG. 16 is a perspective view showing a plant pot and tray system constructed in accordance with a second embodiment of the present invention; and

FIG. 17 is a perspective view showing a plant pot and tray system constructed in accordance with a third embodiment of the present invention.

### DETAILED DESCRIPTION OF THE EXEMPLARY EMBODIMENTS

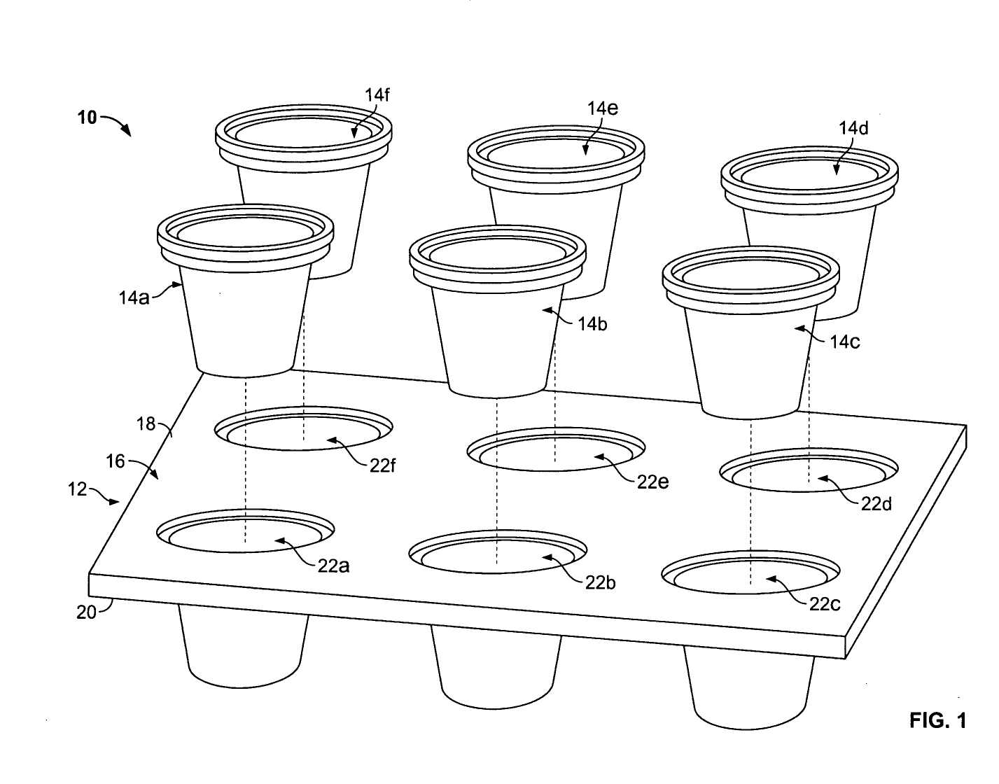

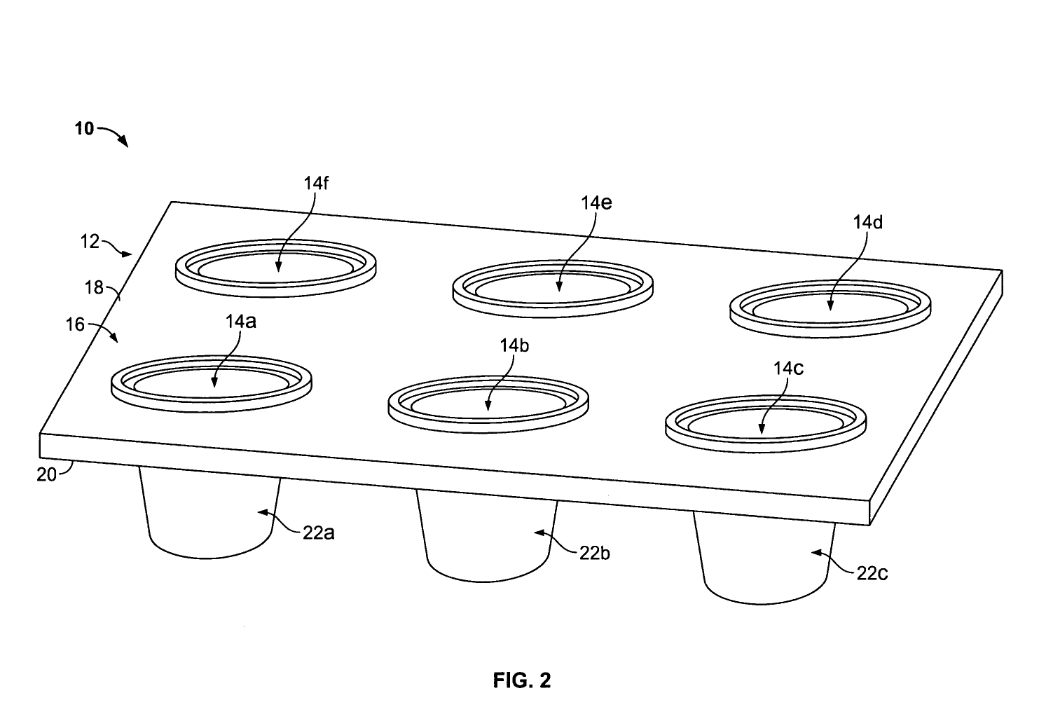

Referring to FIGS. 1-6, a self-orientating plant pot and tray system 10 is shown constructed in accordance with a first embodiment of the invention. The self-orientating system 10 includes a tray 12 and a plurality of plant pots 14a-f received by the tray 12. Each of the tray 12 and the plant pots 14a-f shall be discussed below in further detail.

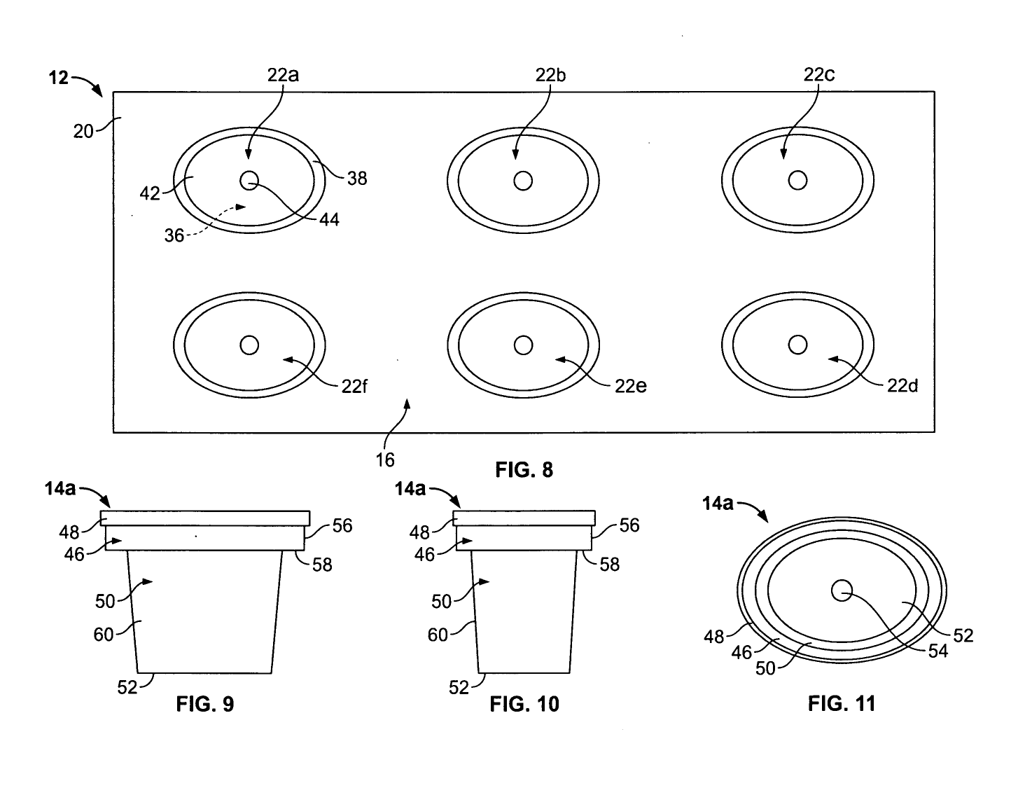

Referring to FIGS. 1-8, the tray 12 is formed of any material suitable for securingly receiving the plant pots 14a-f as herein described, such as polyvinyl chloride (PVC) and/or another plastic or polymer such as those commonly used to make planting pots and trays therefore. As the tray 12 may be rested upon an environmental surface, such as shelf, the material is preferably of a strength to provide structural support to the self-orientating system 10.

The tray 12 includes a tray body 16 having a first tray side 18 and a second tray side 20 generally opposite thereto. The shape, dimensions, etc. of the tray body 16 can be selected in accordance with aesthetic considerations. In this regard, design of the tray body 16 can include, for example, a generally rectangular shape where the first and second sides 18, 20 are each generally planar and parallel to the other.

The tray 16 further includes a plurality of receiving areas 22a-f for securingly receiving one of the plant pots 14a-f into to a desired orientation, such as by virtue of a downward gravitational force and an interference fit between one of the plant pots 14a-f and a corresponding one of the receiving areas 22a-f. It shall be understood that the tray 12 can include any suitable number of receiving areas 22a-f selected in accordance with aesthetic considerations, and that the position along the tray body 16 of one of the receiving areas 22a-f relative to another one of the receiving areas 22a-f can also be selected in accordance with aesthetic considerations. An exemplary discussion of the receiving area 22a of the tray 12 shall now be provided with further detail, though it shall be understood that such discussion is equally applicable to the receiving areas 22b-f.

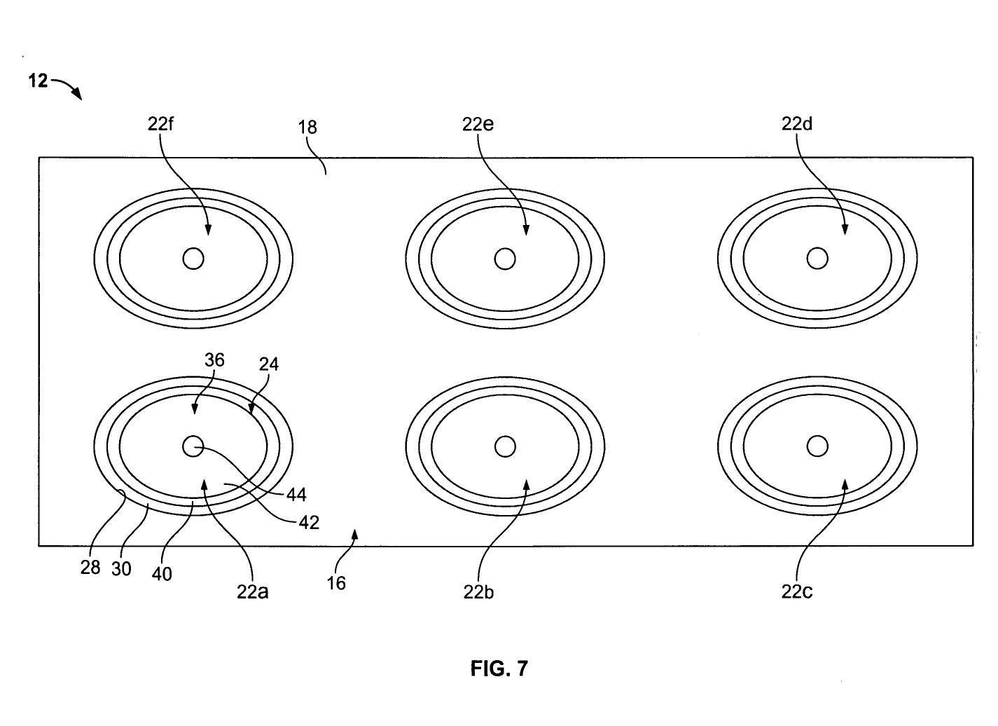

Referring to FIGS. 7-8 and 15, the receiving area 22a is shown to include both a depression 24 and a receptacle 26, each for mating with the pot 14a. It is contemplated, however, that the receiving area 22a can include the depression 24 and/or the receptacle 26. Each of the depression 24 and the receptacle 26 shall be discussed below in turn. The receiving area 22a is preferably orientated about a central axis A_{RA}.

The depression 24 includes a substantially elliptical wall 28 extending from the first tray side 18 toward the second tray side 20 and further includes a substantially elliptical ledge 30 spaced apart from the first tray side 18 by the substantially elliptical wall 28. The substantially elliptical wall 28 and the substantially elliptical ledge 30 define in the depression 24 of the receiving area 22a a chamber, which is referenced herein as an upper chamber 32, and which will be discussed further below in connection with the plant pot 14a. The depression 24 has a substantially elliptical cross-section. Such substantially elliptical cross-section is preferably continuous along at least a part of an elevation E_{D} of the depression 24 of the receiving area 22a, and, more preferably, along the entirety of the elevation E_{D} of the depression 24 of the receiving area 22a.

The receptacle 26 includes a sidewall 34 and chamber defined thereby, which is referenced herein as a body chamber 36, and which will be discussed further below in connection with the plant pot 14a. As shown, the sidewall 34 includes an outer surface 38 extending from the second tray side 20 and an inner surface 40 extending from the substantially elliptical ledge 30, such that the receptacle 26 can be characterized as being a substantially hollow “leg” of the tray 12. Embodiments of the invention are contemplated where the inner surface 40 of the receptacle 26a can extend directly from the first tray side 18.

Referring to FIG. 14, the receptacle 26, the sidewall 34, the body chamber 36, etc. can be provided with a substantially elliptical cross-section. The substantially elliptical cross-section is preferably continuous along at least a part of an elevation E_{R} of the receptacle 26 of the receiving area 22a, and, more preferably, along the entirety of the elevation E_{R} of the receptacle 26 of the receiving area 22a.

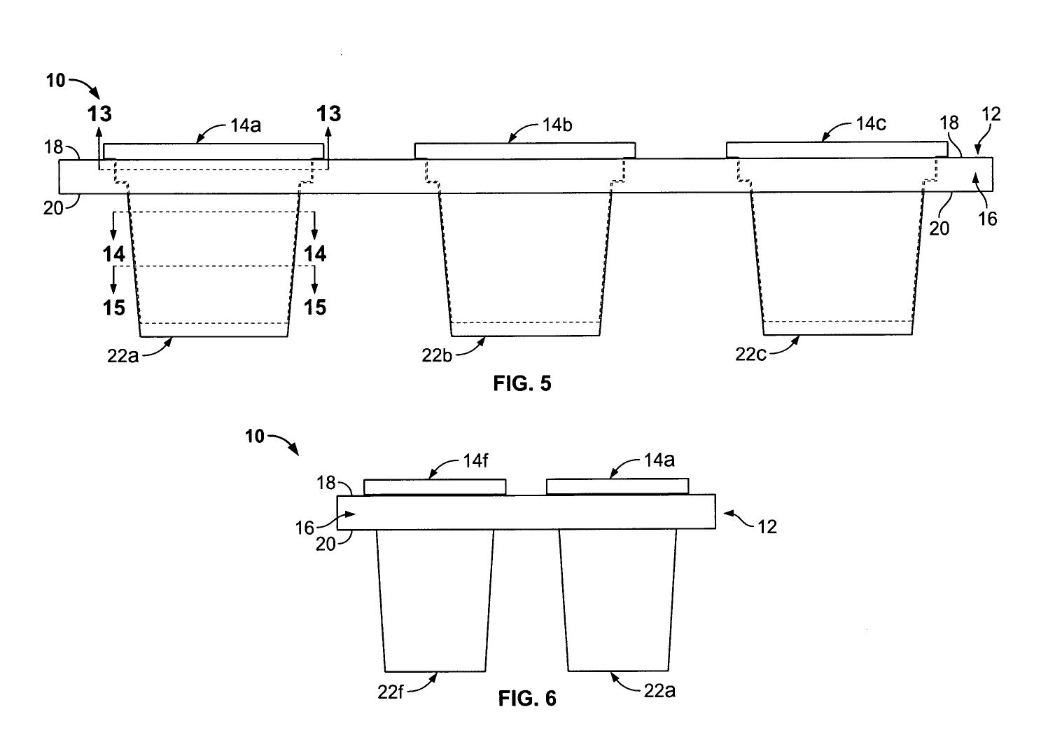

More particularly, and referring to FIGS. 14 and 15, the substantially elliptical cross-section of the receptacle 26, the sidewall 34, the body chamber 36, etc. preferably comprise a tapering substantially elliptical cross-section. For example, the cross-section along section line 14-14 of FIG. 5 (FIG. 14) is of a first area REC₁ and the cross-section along section line 15-15 of FIG. 5 (FIG. 15) is of a second area REC₂ less than the first area REC₁. The tapering substantially elliptical cross-section is preferably continuous along at least a part of the elevation E_{R} of the receptacle 26 of the receiving area 22a, and, more preferably, along the entirety of the elevation E_{R} of the receptacle 26 of the receiving area 22a. In this regard, the receptacle 26 preferably has the shape of a conventional frustum, but with a tapering substantially elliptical cross-section along an elevation thereof. As shown, the receptacle 26 is tapered in a direction opposite the tray body 16.

An advantage of the substantially elliptical cross-section(s) of the receptacle 26 is that such cross-section is non-circular (at least in part) and thus inhibits rotation of the plant pot 14a about the axis A_{RA} when received into the receiving area. In this regard, the term “substantially elliptical cross-section” should be construed as including a cross-section having any suitable shape, so long as such shape comprises, consists, and/or consists essentially of curves not substantially forming a circle. Naturally, the absence of a circular perimeter is not required at all elevations along the receiving area 22a, because some absence only of a circular perimeter about the axis A_{RA} would effect the purpose of inhibiting rotation about the axis A_{RA}. Notwithstanding, it is contemplated that a cross-section having a perimeter consisting essentially of curves not forming a circle can extend continuously along the elevation E_{L}, for example, and that such perimeter can be continuously tapered along the elevation E_{L}, for example.

The receptacle 26 is provided with a tray bottom surface 42 configured to support the tray 12 when rested upon an environmental structure. As shown, the tray bottom surface 42 is provided as a substantially-elliptical end wall extending inwardly from the sidewall 34. The tray bottom surface 42 is preferably provided with an opening extending therethrough, which is referenced herein as a tray drain opening 44.

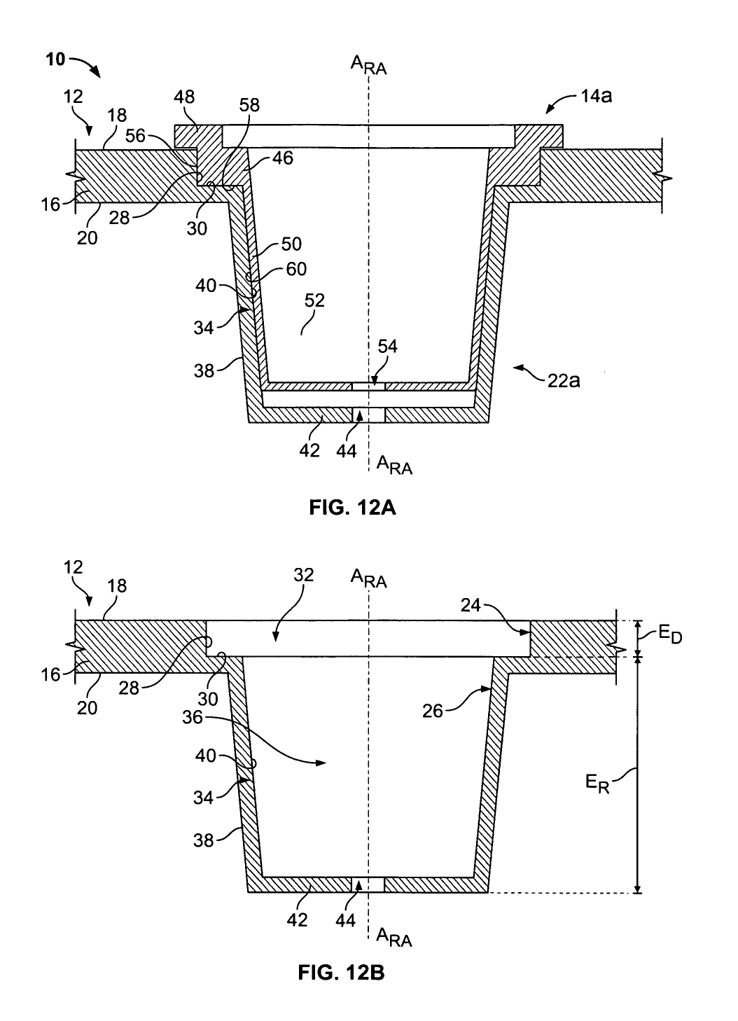

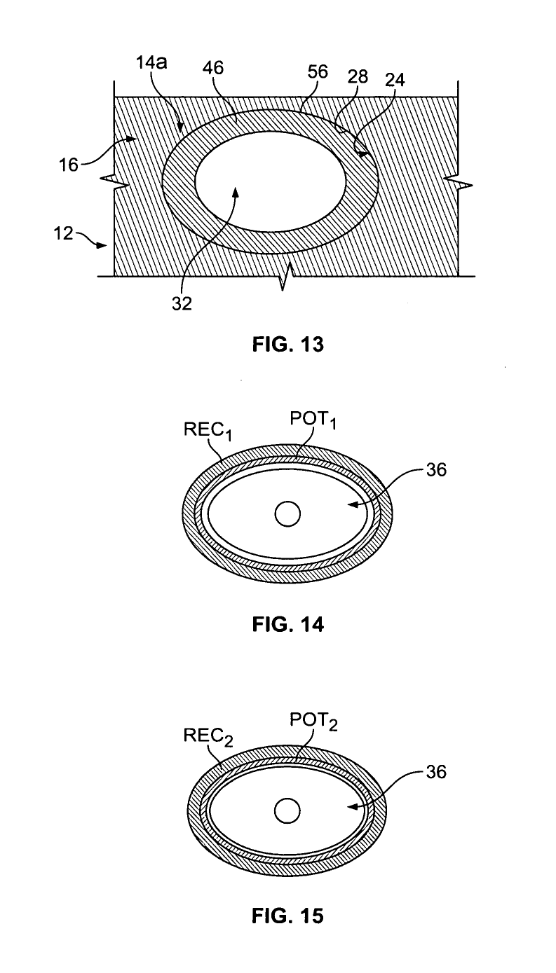

Referring to FIGS. 1-6 and 9-15, the self-orientating system 10 includes the plurality of plant pots 14a-f. An exemplary discussion of the plant pot 14a shall now be provided with further detail, though it shall be understood that such discussion is equally applicable to the plant pots 14b-f. Furthermore, while exemplary discussion is further provided below with regards to the interaction and relationships between the plant pot 14a and the receiving area 22a, it shall be understood that such discussion is equally applicable with regards to the respective interactions and relationships between the plant pots 14b-f and the receiving areas 22b-f corresponding thereto. It shall be further understood that the present invention is not limited to a self-orientating system having each one of the plant pots thereof identical to each other one of the plant pots thereof.

Continuing with reference to FIGS. 1-6 and 9-15, the plant pot 14a is provided with a top 46, a flange 48 extending outwardly from a first end of said top 48 (not designated), and a pot body 50 extending from a second end of said top 46 opposite said first end (not designated). The plant pot 14a defines a chamber therein (not designated), which is configured to receive soil, plants, flowers, etc. The plant pot 14a can include a pot bottom wall 52 extending inwardly from an end of said pot body 50 opposite said top 46, and a drain opening 54 is defined in the plant pot 14a, preferably through the pot bottom wall 52 in communication with the chamber within the plant pot 14a.

The top 46 includes an outer surface, which is referenced herein as a top outer surface 56, and a bottom surface, which is referenced herein as a top lower surface 58. The top 46 preferably has a substantially elliptical cross-section, and, in this regard, each of the top outer surface 56 and the top lower surface 58 preferably has a substantially elliptical shape, e.g., at least a substantially elliptical perimeter. Such substantially elliptical cross-section is preferably continuous along at least a part of an elevation (not designated) of the top 46, and, more preferably, along an entire elevation (not designated) of the top 46. The cross-section of the top 46 preferably corresponds to the cross-section of the depression 24, such that the top 46 is configured to mate with the depression 24 by being received into the upper chamber 32. In use, e.g., when the self-orientating system 10 is provided in assembled form, the top 46 mates with the upper chamber 32. The downward gravitational force seats the top lower surface 58 upon the substantially elliptical ledge 30. Moreover, the top outer surface 56 and the substantially elliptical wall 28 form an interference fit, thereby preventing rotation of the plant pot 14a about the axis A_{RA}. The flange 48 is configured to be seated upon the first tray side 18 by virtue of the downward gravitational force, and, when the self-orientating system 10 is assembled.

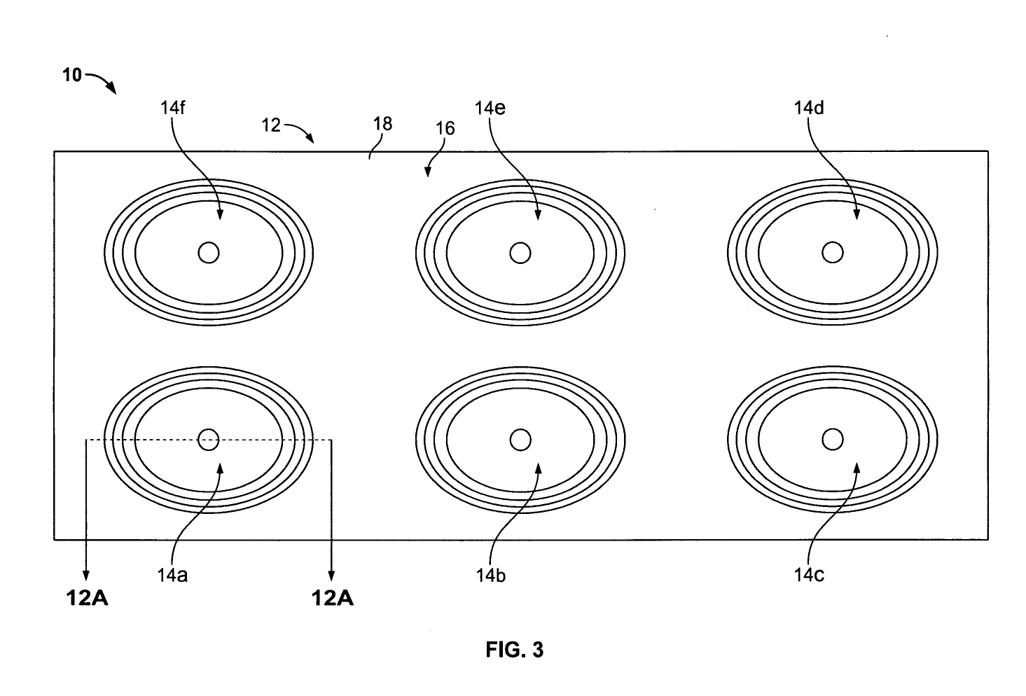

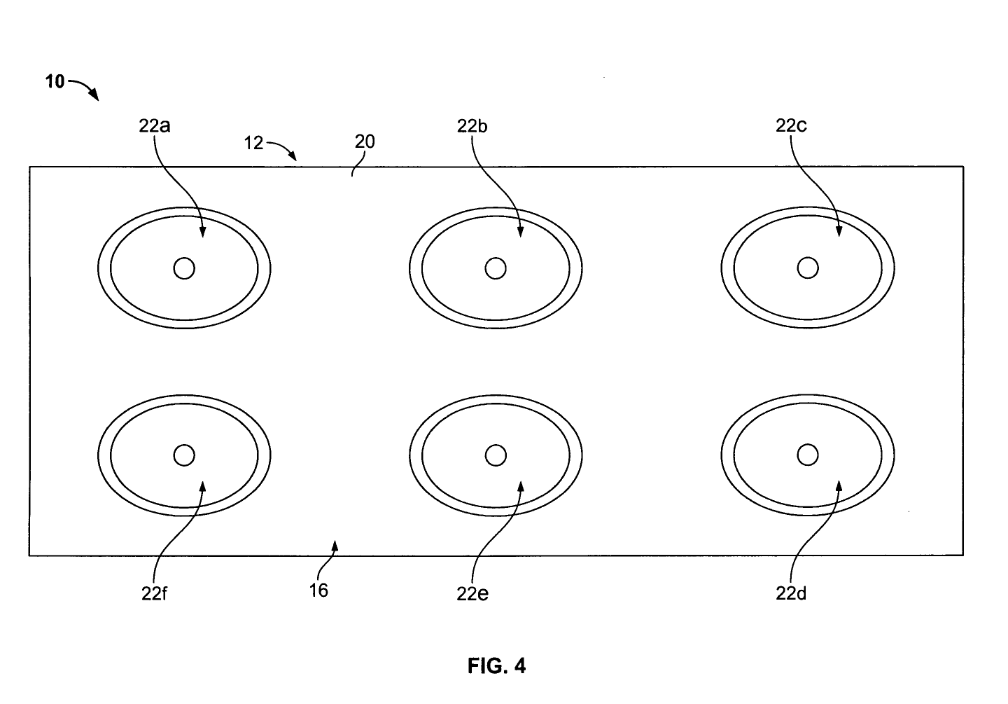

Referring to FIGS. 4 and 12A-15, the pot body 50 has an outer surface, referenced herein as a body outer surface 60, which is configured, such that, when the pot 14a is assembled with the tray 12, the body outer surface 60 faces the inner surface 40 of the receptacle 26. The pot body 50 preferably has a substantially elliptical cross-section and is sized, shaped, and dimensioned to mate with the body chamber 36. The substantially elliptical cross-section of the pot body 50 is preferably continuous along at least a part of an elevation of the pot body 50 (not designated), and, more preferably, along the entirety of the elevation of the pot body 50.

More particularly, the pot body 50 can be provided with a tapering substantially elliptical cross-section. For example, the cross-section along section line 14-14 of FIG. 5 (FIG. 14) is of a first area POT₁ and the cross-section along section line 15-15 of FIG. 5 (FIG. 15) is of a second area POT₂ less than the first area POT₁. Such tapering substantially elliptical cross-section is preferably continuous along at least a part of the elevation of the pot body 50, and, more preferably, along the entirety of the elevation of the pot body 50. In this regard, the pot body 50 preferably has a shape of a conventional frustum, but with a substantially-elliptical cross-section at the points along an elevation thereof. As shown, the pot body 50 is tapered in a direction opposite the top 46.

Similar to the above discussion concerning the receiving area 22a of the tray 12, the term “substantially elliptical cross-section,” when used to describe the plant pot 14a, should be construed as comprising a cross-section having any shape, so long as such shape includes curves not substantially forming a circle. The substantially elliptical cross-sections can include any suitable shape comprising, consisting, and/or consisting essentially of curves not substantially forming a circle, such that, when the self-orientating system 10 is assembled, the plant pot 14a is inhibited from rotation about the axis A_{RA} by virtue of an interference fit with the receiving area 22a.

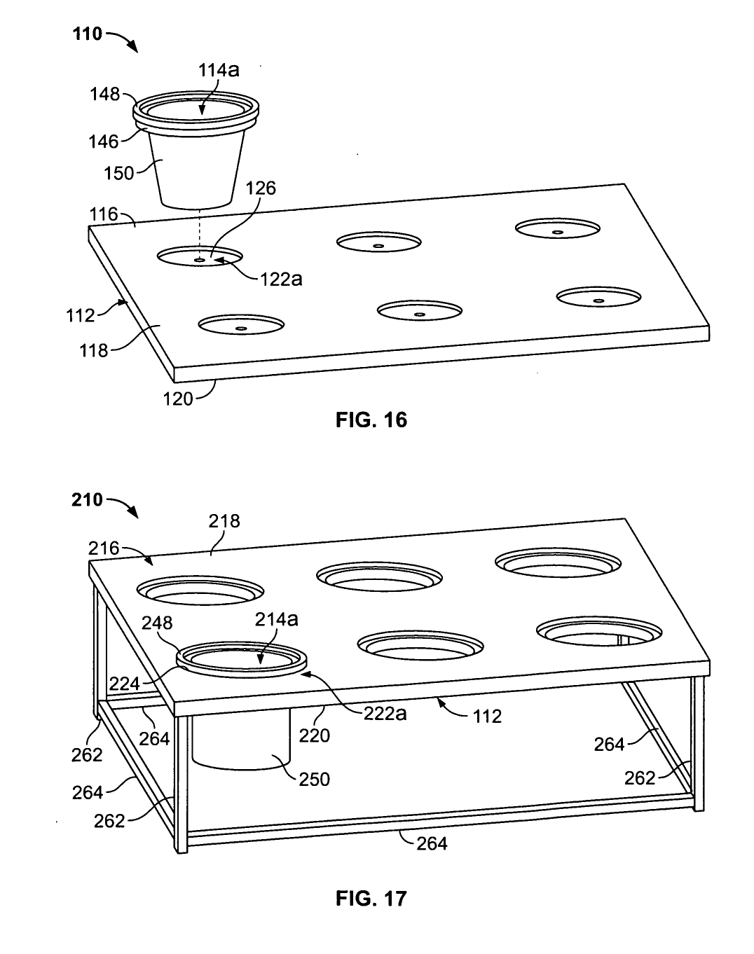

Referring to FIG. 16, a self-orientating system 110 is shown constructed in accordance with a second embodiment of the present invention. Elements illustrated in FIG. 16 which correspond substantially to the elements described above with reference to FIGS. 1-15 have been designated by corresponding reference numerals increased by one hundred. The embodiment of the present invention shown in FIG. 16 is constructed and used in manners consistent with the foregoing description of the self-orientating system 10 shown in FIGS. 1-15, unless it is stated otherwise.

Continuing with reference to FIG. 16, the self-orientating system 110 can be provided with a tray 112 having a tray body 116 and a plurality of receiving areas, such as receiving area 122a. A plurality of pots can be provided, such as the plant pot 114a shown, which has a top 146, a flange 148, and a pot body 150. The receiving area 122a includes a receptacle 126 that extends from a first tray side 118 partially toward a second tray side 120 to define a body chamber. The receptacle 126 (and the body chamber) of the receiving area 122a has a substantially elliptical cross-section, and the bottommost area of the plant body 150 has a substantially elliptical cross-section configured to mate with the body chamber of the receptacle 126 of the receiving area 122a. In this regard, the plant pot 114a is configured to sit atop the tray 112 and partially within the receptacle 126 of the receiving area 122a, so as to securingly align the plant pot 114a with respect to the tray 112. The top 146 and the flange 148 can have any suitable cross-section shape, including a circular cross-section.

Referring to FIG. 17, a self-orientating system 210 is shown constructed in accordance with a third embodiment of the present invention. Elements illustrated in FIG. 17 which correspond substantially to the elements described above with reference to FIGS. 1-15 have been designated by corresponding reference numerals increased by two hundred. The embodiment of the present invention shown in FIG. 17 is constructed and used in manners consistent with the foregoing description of the self-orientating system 10 shown in FIGS. 1-15, unless it is stated otherwise.

Continuing with reference to FIG. 17, the self-orientating system 210 can be provided with a tray 212 having a tray body 216 and a plurality of receiving areas, such as a receiving area 222a. The tray 212 is provided with a plurality of legs 262 for spacing the tray body 216 apart from an environmental surface upon which the legs 262 rest. To provide additional structural support, the tray 212 can be provided with braces 264 each extending from one of the legs 262 to another one of the legs 262 adjacent thereto. A plurality of pots can be provided, such as the plant pot 214a shown, which has a top 246, a flange 248, and a pot body 250. The receiving area 222a includes a depression 224 that extends between a first tray side 218 and a second tray side 220. The plant pot 214a is configured, such that the pot body 250 extends through and under the tray body 216, while the plant pot 214a is supported by the depression 224, which seats the top 248. The depression 224 of the receiving area 222a has a substantially elliptical cross-section, and the top 246 has a substantially elliptical cross-section configured to mate therewith so as to securingly align the plant pot 214a in a desired orientation. The pot body 250 can have any suitable cross-section shape, including a circular cross-section.

It shall be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A self-orientating plant pot and tray system comprising:
a plant pot having a first substantially elliptical cross-section and having a first drain opening; and
a tray having a receiving area for receiving said plant pot, said receiving area having a chamber of a second substantially elliptical cross-section corresponding to said first substantially elliptical cross-section and configured to mate with said plant pot.

2. The system of claim 1, wherein said plant pot includes a top having said first substantially elliptical cross-section, and wherein said receiving area includes a depression defining said chamber as an upper chamber having said second substantially elliptical cross-section and configured to mate with said top.

3. The system of claim 2, wherein said plant pot includes a pot body proximal said top, and wherein said receiving area includes a receptacle tapering in a direction away from said depression and having a body chamber configured to receive said pot body of said plant pot.

4. The system of claim 2, wherein said plant pot includes a flange extending from said top, said flange configured to rest upon a side of said tray when said top mates with said upper chamber.

5. The system of claim 2, wherein said tray includes a first tray side and a second tray side opposite thereto, and wherein said depression includes a substantially elliptical wall extending from said first tray side in a direction toward said second tray side and further includes a substantially elliptical ledge extending from said substantially elliptical wall, said top configured to be seated upon said substantially elliptical ledge at least partially within said substantially elliptical wall.

6. A self-orientating plant pot and tray system comprising:
a plant pot having a first tapering substantially elliptical cross-section and a first drain opening; and
a tray including a receiving area for receiving said plant pot, said receiving area having a chamber of a second tapering substantially elliptical cross-section corresponding to said first tapering substantially elliptical cross-section and configured to mate with said plant pot.

7. The system of claim 6, wherein said plant pot includes a pot body having said first tapering substantially elliptical cross-section, and wherein said receiving area includes a receptacle defining said chamber as a body chamber having said second tapering substantially elliptical cross-section and configured to mate with said pot body.

8. The system of claim 7, wherein said plant pot includes a top proximal said pot body such that said receptacle tapers in a direction away from said top, and wherein said receiving area includes a depression proximal said receptacle and configured to receive said top.

9. The system of claim 7, wherein said receptacle is truncated to provide a bottom surface configured to support said tray when rested upon an environmental structure.

10. The system of claim 7, wherein said receptacle is continuously tapered so as to provide a continuously tapered substantially elliptical cross-section along an entire elevation of said receptacle.

11. A self-orientating plant pot and tray system comprising:
a plant pot including a top having a first substantially elliptical cross-section, and further including a pot body proximal said top and having a first tapering substantially elliptical cross-section, said plant pot having a first drain opening; and
a tray having a receiving area for receiving said plant pot, said receiving area including an upper chamber of a second substantially elliptical cross-section corresponding to said first substantially elliptical cross-section and configured to mate with said top and a body chamber of a second tapering substantially elliptical cross-section corresponding to said first tapering substantially elliptical cross-section and configured to mate with said pot body.

12. The system of claim 11, wherein said tray has a tray drain opening configured for fluid communication with said first drain opening.

13. The system of claim 11, including a kit comprising said tray and said plant pot unassembled therewith.

14. The system of claim 11, including a second plant pot including a second top having a third substantially elliptical cross-section and a second pot body proximal said second top and having a third tapering substantially elliptical, said second plant pot having a second drain opening; and said tray having a second receiving area for receiving said second plant pot, said second receiving area including a second upper chamber of a fourth substantially elliptical cross-section corresponding to said third substantially elliptical cross-section and configured to mate with said second top, and further including a second body chamber of a fourth tapering substantially elliptical cross-section corresponding to said third tapering substantially elliptical cross-section and configured to mate with said second pot body.

15. The system of claim 11, wherein said receiving area includes a depression having said upper chamber.

16. The system of claim 11, wherein said receiving area includes a receptacle having said body chamber.

17. The system of claim 16, wherein said receptacle is continuously tapered so as to provide a continuously tapered substantially elliptical cross-section along an entire elevation of said receptacle.

18. A self-orientating plant pot and tray system comprising:
a plant pot having a first drain opening, said plant pot having a first cross-section defined by a first perimeter consisting essentially of curves not substantially forming a circle; and
a tray having a receiving area for receiving said plant pot, said receiving area including a second cross-section corresponding to said first perimeter, said second cross-section defined by a second perimeter consisting essentially of curves not substantially forming a circle, said receiving area being configured to mate with said plant pot to securingly align said receiving area.

19. The system of claim 18, wherein said plant pot includes a top having said first cross-section, wherein said receiving area includes a depression having said second cross-section and configured to mate with said top.

20. The system of claim 18, wherein said plant pot includes a pot body having said first cross-section, wherein said receiving area includes a receptacle having said second cross-section and configured to mate with said pot body.

21. The system of claim 18, wherein said second cross-section defined by said second perimeter consisting essentially of curves not substantially forming said circle, is continuous along at least a part of an elevation of said receiving area.

22. The system of claim 18, wherein said second cross-section defined by said second perimeter consisting essentially of curves not substantially forming said circle, is continuously tapered along at least a part of an elevation of said receiving area.
